(19) United States
(12) Patent Application Publication
(10) Pub. No.: US 2008/0197314 A1
(43) Pub. Date: Aug. 21, 2008

(54) Fuel Injector With a Housing, and Method For Finishing and Labeling the Housing

(76) Inventors: Tim Bohlmann, Zeitlarn (DE); Michael Denzler, Regensburg (DE); Stefan Kohn, Hohenburg (DE); Yavuz Kurt, Cham (DE); Klaus Plecher, Zeitlarn (DE); Emanuel Sanftleben, Pfatter (DE); Marcus Unruh, Zeitlarn (DE); Claus Zumstrull, Regenstauf (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/916,238

(22) PCT Filed: May 23, 2006
(86) PCT No.: PCT/EP06/62546

§ 371 Date: Nov. 30, 2007

(30) Foreign Application Priority Data
Jun. 1, 2005 (DE) 10 2005 025 147.1

(51) Int. Cl. F16K 27/00

(52) U.S. Cl. 251/366

(57) ABSTRACT

A fuel injector has a housing for an actuator (1), especially to a fuel injector with a connector of a contact stud support injection-molded thereto. The injector has a casing (10), disposed across at least part of the periphery of the actuator (1), and an actuator cover (20) placed on the casing (10). The actuator cover (20) is laser-welded to the casing (10) in an overlapping area (30) between the actuator cover (20) and the casing (10). According to a method for finishing the housing of a fuel injector having the aforementioned features, a laser beam used for a laser welding method is incident on the overlapping area (30) in a substantially perpendicular or substantially parallel orientation in relation to the axial direction (A) of the actuator (1) and laser-welds the actuator cover (20) to the casing (10).

### CROSS-REFERENCE TO RELATED APPLICATIONS

This application is a U.S. national stage application of International Application No. PCT/EP2006/062546 filed May 23, 2006, which designates the United States of America, and claims priority to German application number 10 2005 025 147.1 filed Jun. 1, 2005, the contents of which are herby incorporated by reference in their entirety.

### TECHNICAL FIELD

The invention relates to a fuel injector with a housing, in particular a fuel injector with, at a distance from the injector needle, an injection-molded connector of a contact stud support for a piezoactuator. The invention also relates to a method for finishing the housing and to a method for laser-labeling, in particular, a laser-transparent cover of the housing.

### BACKGROUND

The service life of piezo drives for fuel injectors depends, besides their generally limited service life, in particular on the installation environment of the piezo drive. The piezo drive of a fuel injector is particularly susceptible to engine oil and fuel, whereby, if engine oil or fuel reaches the piezo drive, the maximum service life thereof is shortened. In addition to this, it has been shown that the service life of a piezo drive with a “hermetically” sealed piezo housing arrangement which is built in an installation environment having harmful media is not prolonged but instead is shortened. This may stem, for example, from the fact that under temperature fluctuations and consequently intermittently prevailing low pressure in the sealed housing arrangement harmful media is however sucked into the housing arrangement since such housings can never be designed so as to be completely fluid-tight. On the other hand, it may stem from the fact that during operation inside the piezo drive the concentration of a gas which shortens the service life of the piezo drive is raised in the interior of the piezo housing arrangement, or that an atmosphere similar to atmospheric air inside the piezo housing arrangement has a positive effect on the service life of a piezoelectric ceramic.

These requirements result in a piezo drive whose housing arrangement lies opposite a nozzle needle, which housing arrangement serves to seal the piezo drive accordingly and to connect an electric power supply thereto, being embodied such that it enables a removal of the harmful media from the interior of the housing, but at the same time prevents a penetration of the harmful media into the piezo housing arrangement.

To this end, a piezo stack of the piezo drive is sealed on top by means of a sealing element which is fixed in relation to a housing by a contact stud support which permits the electrical contacting of the piezo stack from outside. The sealing element in this case is embodied as a liquid-tight but gas-permeable sealing element. This ensures that on the one hand gases arising in the piezo stack can be discharged to the outside and ambient air can reach the upper area of the piezo stack, but on the other hand that harmful liquid media cannot enter an area directly via the piezo stack. In order that the gases can escape between the sealing element and the contact stud support, the latter is fitted with a through-hole or a slot.

In order that no liquid or as little liquid as possible passes through the contact stud support to the sealing element, it is necessary in a subsequent production step to extrusion-coat with plastic or to mold with epoxy resin the contact stud support which, viewed axially, is located above the sealing element and completely encloses this sealing element. It is also necessary, to ensure the electrical operating safety of the piezo drive, to cover the upper area permanently and securely. In addition, it is necessary for a traceability of the piezo drive and of the fuel injector to label these. Currently labeling takes place only in the case of one-piece connector encapsulation or covering. Labeling of the fuel injector when assembled or built should be provided on a side of the fuel injector that is as readily accessible as possible from outside.

Extrusion-coating with plastic or molding with epoxy resin of the side of the piezo drive that is remote from the nozzle needle restricts again the good ventilation of the sealing element and consequently of the piezo drive already achieved by means of the contact stud support.

### SUMMARY

A housing for an actuator of a fuel injector and a method for the finishing thereof which on the one hand achieves a good ventilation of the contact upper surface of the piezo drive and at the same time prevents a surging through of liquid to the upper surface of the piezo drive and a penetration of solid objects, but on the other hand additionally enables fuel or engine oil that has entered into this area to run out can be provided. A sealing arrangement can be provided in particular for a diesel common-rail injector arranged completely under a cylinder-head cover of a vehicle engine, which sealing arrangement seals an actuator interior against engine operating media, but is at the same time permeable for gaseous media. There also exists a need, in order to ensure the traceability of the fuel injector, to enable labeling of the housing.

According to an embodiment, a fuel injector with a housing for an actuator may comprise a casing disposed around the actuator at least partially in a peripheral direction and an actuator cover placed on the casing, wherein, in an overlapping area between actuator cover and casing, the actuator cover is laser-welded to the casing.

According to another embodiment, an engine may comprise a fuel injector with a housing for an actuator comprising a casing disposed around the actuator at least partially in a peripheral direction and an actuator cover placed on the casing, wherein, in an overlapping area between actuator cover and casing, the actuator cover is laser-welded to the casing, and, wherein the fuel injector is disposed substantially fully below a cylinder head of the engine.

According to yet another embodiment, a method for finishing a housing of a fuel injector with a housing for an actuator, a casing disposed around the actuator at least partially in a peripheral direction and an actuator cover placed on the casing, may comprise the steps of: using a laser beam for a laser-welding method in an overlapping area in a substantially perpendicular or substantially parallel orientation to the axial direction of the actuator wherein the laser-welding method laser-welds the actuator cover to the casing.

According to yet another embodiment, a method for laser-labeling a component which is laser-transparent at a first wavelength, in particular an actuator cover of a fuel injector with a housing for an actuator, a casing disposed around the actuator at least partially in a peripheral direction and an actuator cover placed on the casing, wherein, in an overlapping area between actuator cover and casing, the actuator cover is laser-welded to the casing, the method comprising the step of laser-labeling the component by means of a laser beam which has a second wavelength which differs from the first wavelength such that a change of contrast takes place on the component. According to yet another embodiment, an actuator cover may be obtained from such a method.

### BRIEF DESCRIPTION OF THE DRAWINGS

The invention will be explained in detail below with the aid of exemplary embodiments with reference to the attached drawings, in which:

FIG. 1 shows a cut view of the fuel injector according to an embodiment with an injector housing arranged on top;

FIG. 2 shows the injector according to an embodiment housing from FIG. 1 in an enlarged sectional representation;

FIG. 3 shows a perspective top view of an housing cover according to an embodiment;

FIG. 4 shows a perspective bottom view of the actuator cover from FIG. 3.

### DETAILED DESCRIPTION

According to an embodiment, in a housing for an actuator of a fuel injector, an injection-molded connector, which is open on top and arranged in a peripheral orientation about the actuator, is covered or encapsulated by means of an actuator cover such that a good ventilation of an actuator chamber occurring between the cover and the injection-molded connector is provided. In order to guarantee the necessary fatigue durability of the actuator cover on the injection-molded connector, the actuator cover is fastened by means of a laser-welded method to the injection-molded connector.

Where plastic components, in particular, are exposed to high thermal and mechanical loadings—as in the present case—ultrasonic welding methods are not sufficiently fatigue durable, making a laser-welding method essential since bonding is also out of the question due to the high thermal and mechanical loadings. For the laser-welding method, the actuator cover and the injection-molded connector have an overlapping area extending at least in an axial direction and/or at least in a radial direction of the fuel injector, on which overlapping area the laser bean is incident and laser-welds the actuator cover to the injection-molded connector. By means of this arrangement, no further extrusion-coating of the fuel injector or casting of the injection-molded connector with epoxy resin is necessary, thereby ensuring a simple and cost-effective covering of the piezo drive. The covering of the piezo drive according to an embodiment with a cover prevents an ingression of solid objects into the area of electrical contacting, thereby ensuring the electrical operational reliability of the piezo drive. Moreover, a standard method for connecting plastics can be used, concerning which method adequate knowledge exists for applying it such that fatigue durable results are achieved.

In a first variant, the injection-molded connector consists of a laser-transparent plastic and the actuator cover of a laser-absorbing plastic, the actuator cover being inset in the injection-molded connector which is substantially designed at least partially in the shape of a hollow cylinder in order to achieve an axial overlapping area between actuator cover and injection-molded connector necessary for this purpose. The possibility exists here of welding the actuator cover through the injection-molded connector in the axial area to the injection-molded connector. In doing so, the laser beam does not have to be incident in the axial orientation of the fuel injector but can be incident over the periphery. Here, the laser beam, incident preferably vertically relative to the axial orientation, may vary in an angle of ±6° about its perpendicular position relative to the axial orientation without cuts having to be made in the quality of the welded seam.

In addition to this, the laser-absorbing actuator cover enables a labeling by means of a laser. For this purpose, the actuator cover is preferably manufactured from a laser-optimized plastic which besides its laser-absorbing characteristics guarantees good labeling since upon incidence of a laser optically changing pigments are incorporated which enable a good contrast between laser-labeling and the rest of the actuator cover. In the manufacture of the housing according to an embodiment, the actuator cover can be labeled to the injection-molded connector or thereafter before welding.

In a second variant, the injection-molded connector consists of a laser-absorbing and the actuator cover of a laser-transparent plastic, the actuator cover being placed onto the injection-molded connector at least partially in order to achieve a radial overlapping area between actuator cover and injection-molded connector that is necessary for this purpose. The possibility exists here of welding the actuator cover through this injection-molded connector in the radial area to the injection-molded connector. In the process, the laser beam does not have to be incident in the radial orientation of the fuel injector but can be incident on a periphery of the actuator cover. Here, the laser beam, incident preferably parallel to the axial orientation, may vary in an angle of ±6° about its parallel position relative to the axial orientation without cuts having to be made in the quality of the welded seam.

In an embodiment, the radial overlapping area, which preferably adjoins the axial overlapping area directly, is also provided between the actuator cover and the injection-molded connector, next to the axial overlapping area. This radial overlapping area additionally enables in the first variant a laser-welding of the actuator cover to the connector extrusion-coating on an underside radially inward relative to the actuator cover. In the second variant, this construction additionally enables a laser-welding of the actuator cover to the connector extrusion-coating on an outer collar in an axial direction relative to the actuator cover. This provision of adjoining axial and radial area according to an embodiment also guarantees in both variants greater support of the actuator cover on the connector extrusion-coating. In this case, the laser-weld seam is embodied in a greatly simplified manner as a standing or lying L circulating at least partially between actuator cover and connector extrusion-coating.

In order to improve a gaseous exchange between the actuator chamber embodied between connector extrusion-coating and actuator cover and an environment of the fuel injector, the housing has a through recess extending into the housing, which is preferably embodied as a gap between injection-molded connector and actuator cover.

By virtue of this improved ventilation, the fatigue durability of the piezo stack is increased, and if the position of this recess is arranged appropriately, enables a discharging of engine operating media located in the housing. The provision of the actuator cover and of the slot according to an embodiment ensures a mechanical protection of the electrical contacting of the piezo drive and at the same time a through-flowing of the injector drive with, for example, engine oil. It is also not possible for engine oil or other operating media to surge through the actuator chamber, so the sealing membrane of the piezo stack cannot be fully clogged with liquid. The creation of a liquid-tight but gas-permeable ventilation arrangement between an environment surrounding the injector housing and the piezo stack according to an embodiment results in a considerable prolongation of the service life of the piezo actuator.

With laser-welding plastics, an overlapping geometry of the plastic components to be welded is used, the plastics of the two components being chosen for their respective absorption spectra such that the laser beam firstly penetrates the injection-molded connector and is thereafter absorbed by the laser-absorbing actuator cover (first variant) or such that the laser beam firstly penetrates the actuator cover and is thereafter absorbed by the laser-absorbing injection-molded connector (second variant). The laser-transparent plastic should, in particular, be transparent for a laser in the infrared wavelength range. For laser-welding, a zero gap, i.e. a gap with the smallest possible diameter and partial joining surfaces of the two connecting partners, should be implemented. This zero gap is preferably achieved by means of a force, by virtue of which upon subsequent laser-welding an accumulating fused plastic mass of the two connecting partners forms through a spatially defined fusing of the contact surfaces, which fused mass achieves after cooling a permanent and non-detachable joint.

According to another embodiment, the overlapping area has a peripheral ring section inclined at an angle, preferable a 45° angle, relative to the axial orientation of the fuel injector, it being possible for the zero gap for the laser-welding to be implemented in a simple manner by means of an axial force on the actuator cover. The zero gap can, for example, in other embodiments of the overlapping area, in particular in axial areas, be realized whereby a relevant inner diameter of the injection-molded connector is slightly smaller in the area of the actuator cover to be inset than the relevant external diameter of the actuator cover. By means of a slot in the appropriate area in an axial direction of the injection-molded connector, it is possible to enlarge an inner diameter of the injection-molded connector by an external diameter of the relevant area of the actuator cover and in this manner to provide a necessary radial force. This force can also be realized on the basis of an elastic deformation of the corresponding axial section of the injection-molded connector. It is also possible by means of an axial force to realize the zero gap in radial areas.

According to another embodiment, the overlapping area between actuator cover and injection-molded connector has a step. In this case, the correspondingly stepped section of the injection-molded connector is running at least partially around in a peripheral direction. In addition, a sealing collar can connect on the inside of the actuator cover to the overlapping area, which sealing collar seals the overlapping area in relation to the actuator chamber so that with laser-welding no fused plastic mass can enter the actuator chamber.

According to another embodiment, the actuator cover has at least one clip, extending in an axial direction and substantially rectangular in shape, which can be inset in correspondingly shaped recesses in the injection-molded connector. In this case, the ventilation gap is preferably provided between a front face of the clip and the recess in the injection-molded connector, which ventilation gap extends between injection-molded connector and front face of the clip from the outside to the inside and from there preferably continues further inward in a labyrinthine manner. This labyrinth-like embodiment of the gap according to an embodiment enables an outflow of liquids from the inside of the actuator housing, but prevents a surging of liquids which are washed from outside onto the actuator cover. The labyrinth gap can be guided in its course almost randomly by means of an appropriate design or appropriate recesses in the axial and radial area of the overlapping area or an appropriate design of the actuator cover in the inside or an appropriate design of the injection-molded connector.

According to another embodiment, in a method for finishing an actuator housing of a fuel injector, the laser beam used for the method can be for the first variant incident in the overlapping area between actuator cover and injection-molded connector in a substantially perpendicular orientation relative to the axial orientation of the fuel injector. The laser beam used for the method can be for the second variant incident in the overlapping area between actuator cover and injection-molded connector in a substantially perpendicular orientation relative to the radial orientation of the fuel injector.

For a laser labeling of a component, laser-transparent preferably in the infrared wavelength range, e.g. of the actuator cover according to the second variant, a laser is used which has a wavelength which differs, preferably significantly, from that used for the laser-welding method. This enables a simple and cost-effective design, since on the one hand laser-welding and laser-labeling can be carried out in the same device and a standard welding method can be applied for the fixing of the actuator cover and on the other hand a simply constructed, one-part cover can be used for the labeling.

If the component is laser-transparent in the infrared wavelength range, then a laser in ultraviolet or visible light is suitable for the laser labeling. In particular, in the case of a blue laser with a wavelength of approx. 355 nm or a green laser with a wavelength of approx. 532 nm, a pigment change occurs in the material Ultramid B3WG6LT sw23229 manufactured by BASF which is laser-transparent in the infrared wavelength range. Also, laser-transparent materials can be adjusted by means of laser additives such that good pigment changes result. In addition, undyed or natural-colored materials which are laser-transparent in the infrared wavelength range can be labeled with a CO₂ laser.

In addition, in an engine with a fuel injector which for its part has the actuator housing according to an embodiment, the fuel injector is preferably disposed substantially completely below a cylinder head of the engine.

Of course, the geometry of the overlapping area for the laser-welding method, and the arrangement of laser-transparent base housing and laser-absorbing cover (first variant) or of laser-absorbing base housing and laser-transparent cover (second variant) can also be applied to other housings. The geometry of the actuator cover can also be applied to other covers. In addition, the laser-labeling method for the laser-transparent component can also be applied to other laser-transparent components.

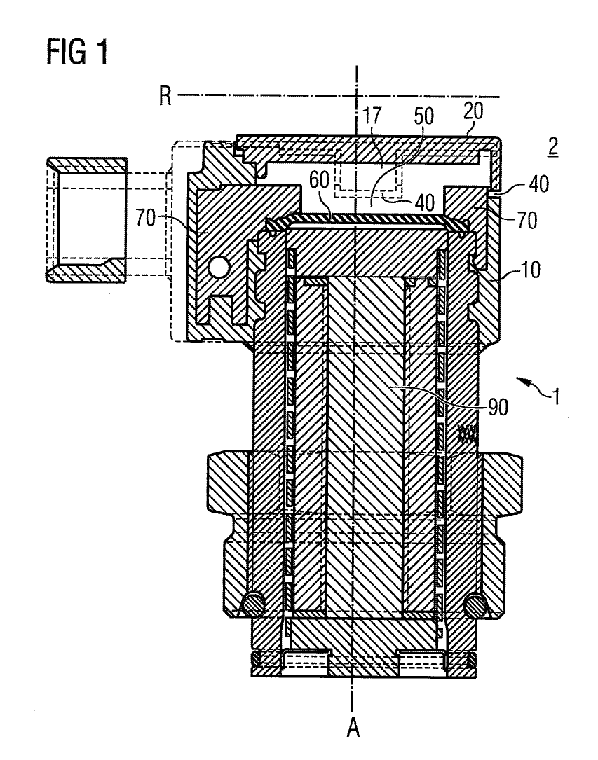

FIG. 1 shows a section of an fuel injector 1 according to an embodiment, the fuel injector 1 having an injector arrangement extending in an axial direction A, in which arrangement a fuel injection nozzle is connected to a piezo drive for actuating the fuel injection nozzle. Here, FIG. 1 shows a top section of the piezo drive which is covered on top by means of a housing. The piezo drive has an actuator 1 and a housing which comprises a casing 10 or a injection-molded connector 10 and an actuator cover 20, the injection-molded connector 10 being closed on top by means of the actuator cover 20. The injection-molded connector 10 is embodied in a substantially fully circular manner in the area of the actuator 1 and has a substantially hollow cylindrical form. Jutting out laterally on the injection-molded connector 10 there is located a device for connecting the actuator 1 to a power supply.

The injection-molded connector 10 which is open on top fixes a contact stud support 70 which secures a liquid-tight and gas-permeable sealing element 60 on the actuator 1. The contact stud support 70 also serves to electrically contact two piezo pins which supply a piezo stack 90 disposed in the actuator 1 with electric current. The contact stud support 70 provides the electric contacts necessary for the electric contacting inside the laterally jutting device of the injection-molded connector 10.

The injection-molded connector 10 is closed on top by means of the actuator cover 20, a gap 40 preferably being embodied between actuator cover 20 and injection-molded connector 10, which gap enables a fluid communication between an actuator chamber 50 and an integral environment 2 of the actuator 1 or of the fuel injector 1. The sealing element 60 disposed inside the actuator chamber 50 seals the actuator 1 in an upper area from its surroundings in a liquid-tight manner, the sealing element 60 being gas-permeable and therefore enabling a ventilation of the piezo stack 90 in the upper area. The air for this can pass into the actuator chamber 50 through the gap 40 between actuator cover 20 and injection-molded connector 10 and from there pass through the gas-permeable sealing element 60 to the upper area of the piezo stack 90. Conversely, harmful media can pass from the area above the piezo stack 90 through the sealing element 60 into the actuator chamber 50 and from there be discharged through the gap 40 into the environment. In this case, the gap 40 is preferably embodied as a labyrinth gap 40 (see below).

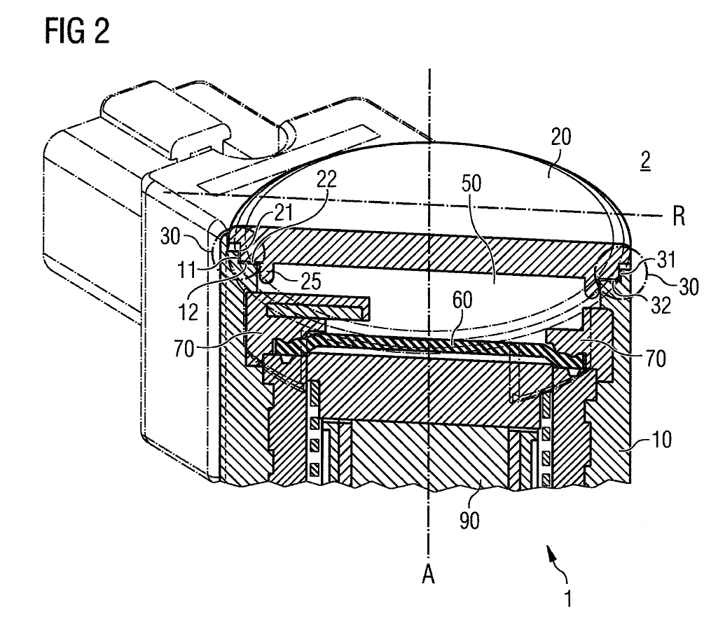

In FIG. 2, the upper area of the injection-molded connector 10 in an overlapping area 30 with the actuator cover 20 can be recognized in an improved manner. Here, the overlapping area 30 between actuator cover 20 and injection-molded connector 10 is defined as being the particular area in which the actuator cover 20 is laser-welded to the injection-molded connector 10. For this purpose, the overlapping area 30 has at least an axial area 31 and/or a radial area 32. In addition, the overlapping area 30 can have an inclined area which defines an angle of between 0 and 180° with the axial direction A. For such an incline, an angle measured from top to bottom of 45° is preferred, which is preferably embodied in an at least partially circular orientation as an annular inclined area between the actuator cover 20 and the injection-molded connector 10. Different combinations of axial areas 31, radial areas 32 and/or inclined areas are of course possible. The corresponding areas 31, 32 and the inclined area are in this case embodied in an at least partially circular manner in a peripheral direction between actuator cover 20 and injection-molded connector 10. These combinations of areas can occur in a peripheral direction and also in a redial direction R or can alternate.

According to another embodiment, coming from the top of the actuator cover 20, the radial area 32 connects to the axial area 31, which areas together form a 90° step. For this overlapping area 30 formed by the two areas 31, 32, the actuator cover 20 has an axial margin 21 and a radial margin 22, and the injection-molded connector 10 has an axial section 11 and a redial section 12. Axial section 11 and axial margin 21 here form the axial area 31 and the radial section 12 and the radial margin 22 here form the radial area 32. A further radial margin, whose outer peripheral edge is preferably flush on the outside with the injection-molded connector 10, is preferably connected on top to the axial margin 21 of the actuator cover 20.

In a laser-welding method for a first variant, actuator cover 20 and injection-molded connector 10 are laser-welded to one another. Here, the laser beam is incident over the periphery of the injection-molded connector 20 in the overlapping area 30 preferably at an approx. 90° angle relative to the axial direction A of the fuel injector 1. The laser beam penetrates the injection-molded connector 10 consisting at least in the overlapping area 30 of a laser-transparent plastic and then strikes in the axial area 31 the axial margin 21 of the actuator cover 20. The actuator cover 20 is constructed at least in its area to be welded (axial margin 21, radial margin 22) from a laser-absorbing material. The laser beam striking the axial margin 21 fuses the material of the actuator cover 20 in the axial area 31, the heat arising there fusing the axial section 11 in the axial area 31; here, the two fused masses of the injection-molded connector 10 and of the actuator cover 20 mix with one another. After cooling, the mixed fused masses form a common bond, thereby securing the actuator cover 20 to the injection-molded connector 10.

In this embodiment, coming from outside, the axial area 31 connects to the radial area 32, whereby in the exemplary embodiment shown in FIG. 2 the upper part of the radial area 32 is formed by the laser-absorbing actuator cover 20 and the lower part by the laser-transparent injection-molded connector 10. The laser bean 30 incident in the axial area 31 heats in turn the actuator cover 20 on the radial margin 22 which for its part emits the heat occurring to the radial section 12, whereby a common bond is likewise formed which after setting secures the actuator cover 20 to the injection-molded connector 10.

In this embodiment, the corresponding axial area 31 and radial area 32 is embodied at least partially in a peripheral direction about the injection-molded connector 10 or the actuator cover 20. It is, however, also possible to fashion a plurality of transitional areas 30 extending in an axial and a radial direction at least partially in a circular manner. It is additionally possible to provide, instead of a combined transitional area 30 of an axial area 31 and a radial area 32, only a radial area 32 between actuator cover 20 and injection-molded connector 10. Preferably, three overlapping areas 30 which are independent of one another are provided in a peripheral direction between actuator cover 20 and injection-molded connector 10, two overlapping areas 30 running around about less than 90°, preferably 45° to 75°, and the third overlapping area 30 running around about less than 180°, preferably 90° to 150°. Similar applies to a sealing collar 25 (see below), connecting to the overlapping area 30, on the actuator cover 20, which sealing collar runs a little further around, however, at the longitudinal ends of the corresponding overlapping areas 30. In another embodiment, the respective sealing collar 25 runs just as far around in a peripheral direction as the corresponding overlapping area 30.

It should, however, be pointed out that the axial area 31 and the radial area 32 do not necessarily have to be provided. It is also possible to provide only the axial area 31 and to undertake a positioning of the actuator cover 20 in an otherwise manner, e.g. via clips 27 (see below), a simple joint which is fashioned from a solid cylinder 23 (see below), or similar.

Furthermore, in another embodiment of the first variant, the laser-absorbing actuator cover 20 can also be laser-welded to the laser-absorbing casing 10 by means of a laser beam incident in an axial direction A. For this purpose, the casing 10 covers the actuator cover on top (i.e. from the direction from which the laser beam comes) at least partially on a peripheral area, preferably an outer peripheral area. The laser beam for the welding method strikes in this case in an axial direction A the part of the casing 10 which covers the actuator cover 20 and fuses the underlying actuator cover 20. The laser-welding takes place in this case principally in a radial area. It is additionally possible to clamp the actuator cover 20 inside an upper section of the casing 10 at least partially.

The first variant of a connection of the preferably one-part, laser-absorbing actuator cover 20 to the laser-transparent injection-molded connector 10 for a second-generation diesel-injector drive makes it possible for the laser beam used for the laser-welding method to be incident in the overlapping area 30 in a radial direction R (preferred embodiment) or an axial direction A of the fuel injector 1. It is not necessary in this case for the laser beam to be incident in the overlapping area 30 in a precisely perpendicular orientation relative to the axial direction A of the fuel injector 1, but it can preferably be incident at an angle of ±6° relative to the perpendicular to the axial direction A. This ensures according to an embodiment a fusing of the two plastics even in the radial area 32.

In order to realize a zero gap for the welding in the overlapping area 30, it is necessary to push the actuator cover with an axial force on to the injection-molded connector 10 and/or in order to provide a radial force on the actuator cover 20 to push the injection-molded connector 10 in an upper area against the actuator cover 20. The latter can be realized, for example, by means of an appropriately small internal diameter design of the injection-molded connector 10 in the radial area 32, a corresponding external diameter of the actuator cover 20 being slightly larger. In this case, either the injection-molded connector 10 deforms elastically in the upper area when the actuator cover 20 is inset, as a result of which a radial force acts on the actuator cover 20; or the injection-molded connector 10 is slotted in an axial direction in its peripheral ring radially through the periphery, as a result of which, when the actuator cover 20 which is fashioned somewhat larger in diameter in the relevant area is inset, the injection-molded connector 10 is expanded, which then exerts a radial force on the actuator cover 20. Through a combination of an axial force via the actuator cover 20 on the face of the injection-molded connector 10 (in respect of the radial area 32) and a radial force from the injection-molded connector 10 on the actuator cover 20 (in respect of the axial area 31), both a radial and an axial zero gap can be achieved in the overlapping area 30.

According to another embodiment, the actuator cover 20 has a sealing collar 25 which connects on the inside to the overlapping area 30. This sealing collar 25 prevents an outflow of the fused mass into the actuator chamber 50 of the actuator 1. Here, the sealing collar 25 can in an embodiment which has only an axial area 31 connect directly to the axial margin 21 of the actuator cover 20 or in an embodiment which has only a radial area 32 connect directly to the radial margin 22 of the actuator cover 20, or as shown in the exemplary embodiment, to the combination of axial area 31 and radial area 32. The sealing collar 25 can here also serve as a centering or guiding collar for the actuator cover 20 on the injection-molded connector 10.

According to another embodiment, the injection-molded connector 10 is constructed fully from a laser-transparent material and the actuator cover 20 fully from a laser-absorbing material and preferably material which can readily be laser-labeled. The plastics suitable for this purpose are preferably Durathane®, the material of the actuator cover 20 according to an embodiment, Durethan® AKV 30 H2.0 LO 901050, being black, and the injection-molded connector 10 of Durethan® AKV 30 H2.0 LT 904040, equipped with transmitting properties, being laser-transparent. If the injection-molded connector 10 and/or the actuator cover 20 respectively should not be manufactured from a single material, then it is important that the injection-molded connector 10 is constructed so as to be laser-transparent at least in the overlapping area 30 and the actuator cover 20 is constructed so as to be laser-absorbing at least in the overlapping area 30.

The actuator cover 20 can preferably be laser-labeled on top, which can best be achieved with a fully laser-absorbing actuator cover 20, but which is not a mandatory requirement. According to another embodiment, the plastic materials of the actuator cover 20 and of the injection-molded connector 10 are embodied in different colors at least in the laser-welding area. Here, the colors should be at least just distinguishable by the human eye without auxiliary means, preferably, however, readily distinguishable, and particularly preferably distinguishable even upon fleeting examination.

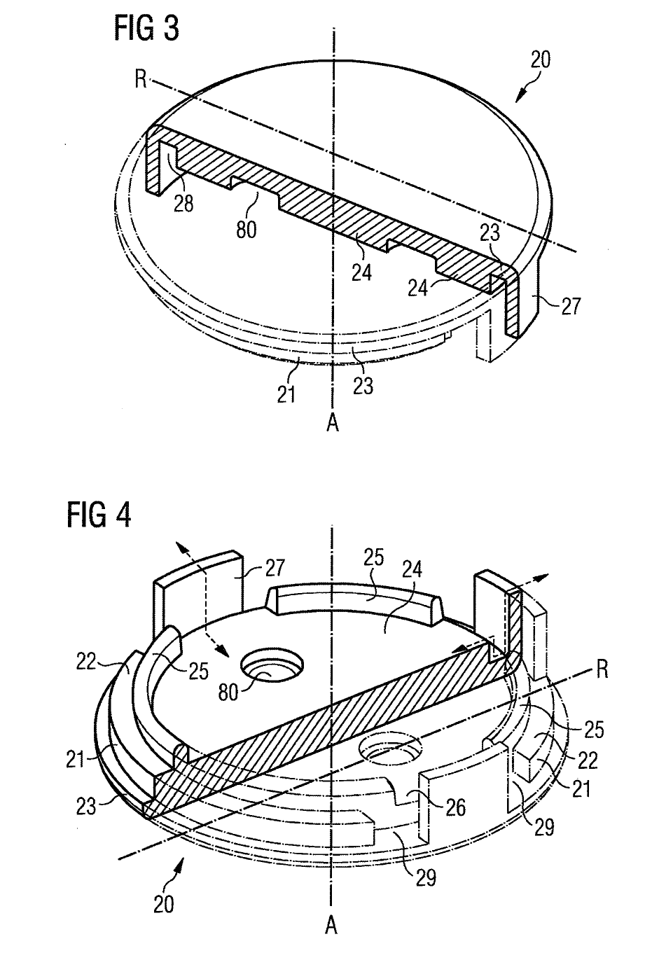

FIGS. 3 and 4 show a preferred embodiment of the actuator cover 20, in which a cross-sectional profile in a diametrical direction across the actuator cover 20 is respectively inscribed in a hatched manner.

FIG. 4 shows the design of the actuator cover 20 according to an embodiment, wherein the top of the actuator cover 20 lies underneath. Here, the actuator cover 20 is constructed essentially from two solid cylinders 23 and 24 arranged concentrically above one another. Here, the preferably somewhat flatter of the two solid cylinders 23 has a greater external diameter than the preferably somewhat thicker solid cylinder 24, which is preferably embodied materially in one piece with the solid cylinder 23.

The actuator cover 20 has at least one clip 27 on its periphery. Here, an outside of the clip 27 is preferably flush with the outer periphery of the solid cylinder 23. According to another embodiment, a plurality of clips 27, preferably 3, are arranged in a distributed manner on the outer periphery. Here, two clips 27 lie diametrically opposite one another, the third clip 27 being arranged midway on a section of the outer periphery between the other two clips 27. A selected clip (far right in FIG. 4) consequently has two other clips 27 respectively adjacent to it at approximately a right angle which lie opposite one another on the periphery. When the actuator cover 20 is assembled with the injection-molded connector 10, the clips 27 are received in corresponding clip recesses 17 in the injection-molded connector 10.

With reference to FIG. 4, the sealing collar 25, which additionally extends radially inwardly relative to the actuator cover 20, is axially connected to an outer periphery of the solid cylinder 24. The sealing collar 25 can here be embodied in a fully circulating manner or, as in the preferred exemplary embodiment shown, be recessed in an area of the clips 27, the sealing collar 27 being recessed preferably to the level of the solid cylinder 23.

Located in a peripheral direction between the clips 27 in the step area between solid cylinder 23 and solid cylinder 24 a rectangular prism curved in the peripheral direction of the actuator cover 20, which conforms with a longitudinal side to the outer periphery of the solid cylinder 24. The curved rectangular prism serves as a step section between solid cylinder 23 and sealing collar 25. The step section preferably extends from the solid cylinder 23 axially to the level of the solid cylinder 24. Here, the step section has on its outer periphery the axial margin 21 to which the radial margin 22 running radially inwardly connects.

The step sections located in a peripheral direction between the clips 27 are recessed in the area around the clips 27. These recesses 29 serve to allow liquid to flow out of the actuator chamber 50 and can form a part of the gap 40.

According to another embodiment, the clips 27 are embodied at a distance from the solid cylinder 24. In addition, according to an embodiment, two piezo pin recesses 80 are located in the solid cylinder 24 which may extend into the solid cylinder 23. These piezo pin recesses 80 serve to receive free ends of piezo pins projecting upwardly out of the actuator 1 so as to enable the cover 20 to be placed onto the injection-molded connector 10.

According to another embodiment, the actuator cover 20 is configured as shown in FIGS. 3 and 4, the proportions not being represented to scale. FIGS. 3 and 4 relate to a relative position of the corresponding sections, areas, recesses and margins of the actuator cover 20 relative to one another.

The gap 40 provided according to an embodiment in the actuator housing is, in its simplest form, a gap 40 which leads directly into the actuator chamber 50. According to another embodiment, this gap 40 is embodied as a simple straight-line gap 40 between a front of a clip 27 and an area of the front of the injection-molded connector 10. Furthermore, the provision according to an embodiment of the gap 40 on a front of a clip 27 of the actuator cover 20 is advantageous as it is in this way possible to provide the gap 40 or a section of the gap 40 below in the actuator housing 50, which enables in a simple manner an outflow of operating media.

The gap 40 in the actuator housing can in another embodiment also extend axially inwardly along the clips 27 to the actuator chamber 50. In this respect, two preferred courses of the gap 40 are represented in FIG. 4 by dashed double-headed arrows. Here, the double-headed arrows illustrate the path of the fluid out of the actuator chamber 50, and the path of the ventilation air into the actuator chamber 50.

In these two cases, the gap 40 extends, coming from outside, along a front of the clip 27 inwardly into the actuator housing, propagates itself inside the actuator cover 20 along the clip 27 axially upwardly (in the assembled state, which can be seen for example in FIG. 1) so as to open at the level of the solid cylinder 24 into the actuator chamber 50. In one case of the gap 40 according to an embodiment, the gap 40 does not open, after continuing along the clip 27, directly at the level of the solid cylinder 24 into the actuator chamber, but continues along the clip 27 to the level of the solid cylinder 23, bridges at approximately this level the interspace between the inside of the clip 27 and the outer peripheral margin of the solid cylinder 24, then runs downward (assembled state) along the outer peripheral margin 24 to the free front face of the solid cylinder 24 and opens there into the actuator chamber 50. In order that the gap 40 can extend up to the level of the bottom of the solid cylinder 23, a web of the injection-molded connector 10 extends into the recess between clip 27, outer margin of the solid cylinder 24 and solid cylinder 23, the dimensions of which web are smaller than the recess formed by the clip 27 and the two solid cylinders 23, 24.

These labyrinth arrangements of the gap 40 according to an embodiment ensure a good ventilation and exhaustion of the actuator chamber 50, ensure a rinsing of the actuator chamber 50, e.g. an outflow of fuel, but prevent engine operating media from surging through the actuator chamber 50.

According to another embodiment, the fuel injector 1 shielded with the actuator housing is integrated into an engine of a motor vehicle such that at least an externally located section of the gap 40 in the integral fuel injector 1 is located below or closely below the lowest point of the actuator cover 20. In addition, according to an embodiment, at least an externally located section of the gap 40 lies, when the fuel injector 1 is integrated, lower than at least one section of the sealing element 60, so that this sealing element can always reliably provide its gas-permeability. According to another embodiment, this applies to the whole gap 40 or large parts thereof.

In a second variant, the actuator cover 20 is laser-transparent and preferably also embodied in one piece, the actuator cover 20 being rigidly connected by means of a laser-welding method to the injection-molded connector 10 or the casing 10. Here, however, the laser beam is incident over the actuator cover 20, preferably over the upper outer periphery thereof, in a direction substantially parallel to the axial direction A or substantially perpendicular to the radial direction R of the fuel injector 1 and is absorbed by the underlying casing 10 which is fused in the process. Here, the casing 10 is designed for the laser-welding method used so as to be laser-absorbing.

It should be pointed out that the radial area 32 and the axial area 31 do not necessarily have to be provided. It is also possible to provide only the radial area 32 and to undertake a centering of the actuator cover 20 in an otherwise manner, e.g. via the clips 27, the sealing collar 25 or similar.

According to another embodiment, the laser-transparent actuator cover 20 can also be laser-welded to the laser-absorbing casing 10 by means of a laser beam incident in a radial direction R. For this purpose, the actuator cover 20 has a collar which preferably covers externally at least partially a preferably upper margin of the casing 10. The laser beam for the welding method here strikes in a radial direction R via the collar of the actuator cover 20 the casing 10 and fuses this casing. Here, the laser-welding takes place principally in an axial area.

For the second variant, the material of the actuator cover 20 is e.g. Durethan® AKV 30 G H2.0 LT 904040 in natural color. Here, the injection-molded connector 10 is different optically and in its transmission properties from the actuator cover 20, the injection-molded connector 10 being e.g. PA in black or consisting of Durethan® AKV 30 H2.0 LO 901050 in black.

The second variant of a connection of the preferably one-part laser-transparent actuator cover 20 to the laser-absorbing injection-molded connector 10 for a second-generation diesel-injector drive according to an embodiment makes it possible to arrange for the laser beam used for the laser-welding method to be incident in the overlapping area 30 in an axial direction A (preferred embodiment) or in a radial direction R of the fuel injector 1. It is not necessary here for the laser beam to be incident in the overlapping area 30 in a precisely perpendicular manner relative to the radial direction R of the fuel injector 1, but can be incident preferably at an angle of ±6° relative to the perpendicular to the radial direction R. This ensures according to an embodiment a fusing of the two plastics even in the axial area 31.

This second variant is, as it were, the “kinematic” converse of the first variant so that what has been said in respect of the first variant also applies analogously in respect of the second variant.

In the second variant, the possibility exists of welding the actuator cover 20 with a suitable laser or laser beam to the injection-molded connector 10 and then, preferably in the same device, of labeling the cover with a traceability code, e.g. a data matrix code, from preferably the same direction (as for the laser-welding). The data matrix code is a 2D code and is used for durable direct labeling e.g. on engine and transmission parts and on tools and on surgical medical instruments. The wavelength λ₂ of the labeling laser has to be chosen, however, such that the laser beam is absorbed on/in the surface of the actuator cover 20 and effects a change in the pigments of the actuator cover 20 or otherwise a difference in contrast. A problem here, however, is that the actuator cover 20 is laser-transparent at least for certain wavelengths λ₁ of laser beams for laser-welding methods.

Laser-welding methods are usually carried out with lasers in the infrared wavelength range from λ₁=808 nm to λ₁=1064 nm. Laser labeling is usually carried out with an Nd:YAG laser likewise with an infrared wavelength of λ₂=1064 nm. With such a combination of laser-welding method and laser-labeling method, no change in the material of the actuator cover 20 takes place with the labeling laser as the actuator cover 20 is transparent for the laser light of the Nd:YAG laser. The wavelength λ₂ of the labeling laser used must therefore be chosen such that the laser beam is absorbed in the actuator cover 20 and a contrast change occurs on the surface. In order to be able to carry out laser labeling on a laser-transparent material, the wavelength λ₂ of the laser beam for the labeling has to lie e.g. in the ultraviolet or visible wave spectrum.

Furthermore, it is e.g. possible that the actuator cover 20 will at one end of the infrared, ultraviolet or visible spectrum be laser-light-transparent for a welding-laser beam of wavelength λ₁ and at the other end of the respective spectrum be laser-light-absorbing for a corresponding labeling-laser beam of wavelength λ₂.

It is generally the case that the wavelengths λ₂ of the labeling-laser beam have to lie so far away from the wavelengths λ₁ of the welding-laser beam that a change of pigments present in the component 20 or another change of contrast at the points of impact of the laser beam on the component 20 can occur. By means of laser additives, the material of the component 20 which is laser-transparent at the wavelength λ₁ can be adjusted such that good or readily visible or readily detectable pigment changes are produced with the method according to an embodiment. Plastics which cannot be laser-labeled can be rendered capable of being labeled through appropriate pigmentation. Additional pigments enable in may plastics color-intense reactions to the laser beam, these being caused both by a reaction in the polymer and in the pigment itself.

Such a labeling of a component 20 or actuator cover 20 that is laser-transparent in the infrared wavelength range λ₁ succeeds e.g. using a blue laser beam (wavelength λ₂=355 nm) or a green laser beam succeeds (wavelength λ₂=532 nm), the laser-transparent material being preferably Ultramid B3WG6LT sw23229 produced by BASF.

A CO₂ laser is also suitable for the method according to an embodiment. This laser generates black colorations on the surface of the component 20 which together with non-blackened parts of the component surface can be provided as e.g. coded markings on the component 20. In particular, undyed plastics such as e.g. gray or natural-colored (i.e. not mixed with additives) plastics generate no pigment change in laser labeling, but can, while retaining their transparency, be marked from light to dark with a CO₂ laser.

The method according to an embodiment which the component that is laser-transparent in a first wavelength range λ₁ by means of a laser which has a wavelength λ₂ that is different, preferably significantly different, from the first wavelength λ₁ can also be transferred to other wavelength ranges.

Laser-transparent is intended in both variants to signify in particular that the laser-transparent partner element in the joint (injection-molded connector 10 in the first variant and actuator cover 20 in the second variant) should be permeable through a certain material thickness for a laser in the infrared wavelength range. Normally, such a material thickness is more than 5 mm, so that sufficient laser energy can still impact on the other partner element of the joint so as to fuse this other element. The other partner element in the joint is in this case the laser-absorbing element. However, in the case of the laser-labeling of the actuator cover 20, this actuator cover is on the one hand laser-transparent for the welding-laser beam and on the other laser-absorbing for the labeling-laser beam.

What is claimed is:

1. A fuel injector with a housing for an actuator comprising
a casing disposed around the actuator at least partially in a peripheral direction and an actuator cover placed on the casing, wherein,
in an overlapping area between actuator cover and casing, the actuator cover is laser-welded to the casing.

2. The fuel injector according to claim 1,
wherein, at least in the overlapping area, the casing is composed of a laser-transparent material and the actuator cover is composed of a laser-absorbing material, and the actuator cover is inset at least partially in the casing and is laser-welded to the casing at least partially in an axial area of the overlapping area.

3. The fuel injector according to claim 1, wherein, at least in the overlapping area, the casing is composed of a laser-transparent material and the actuator cover of a laser-absorbing material, and
the actuator cover is inset at least partially in the casing and is laser-welded to the casing at least partially in a radial area of the overlapping area.

4. The fuel injector according to claim 1, wherein, at least in the overlapping area, the casing is composed of a laser-absorbing material and the actuator cover of a laser-transparent material, and
the actuator cover is placed at least partially on the casing and is laser-welded to the casing at least partially in a radial area of the overlapping area.

5. The fuel injector according to claim 1, wherein, at least in the overlapping area, the casing is composed of a laser-absorbing material and the actuator cover of a laser-transparent material, and
the actuator cover is placed at least partially on the casing and is laser-welded to the casing at least partially in an axial area of the overlapping area.

6. The fuel injector according to claim 1, wherein between casing and actuator cover at least one gap is provided, enabling a fluid communication between an environment of the actuator and an actuator chamber which is embodied between actuator cover and actuator.

7. The fuel injector according to claim 1, wherein the overlapping area has the axial area extending parallel to the axial direction of the actuator, which axial area
is embodied from an axial margin of the actuator cover and an axial section of the casing, wherein
to center the actuator cover on the casing, the axial margin is preferably embodied on an inner periphery of the actuator cover.

8. The fuel injector according to claim 1, wherein the overlapping area has the radial area extending perpendicular to the axial direction of the actuator, which axial area
is embodied from a radial margin of the actuator cover and a radial section of the casing, wherein
the radial margin is preferably embodied on an inner periphery of the actuator cover and preferably connects directly to the axial margin.

9. The fuel injector according to claim 1, wherein the overlapping area has an inclination which
defines an angle of greater than 0° and of less than 180° with the axial direction of the actuator, wherein
the angle is 20° to 70°, preferably 30° to 60°, particularly 40° to 50° and particularly preferably 45°, or exhibits 90° more than that.

10. The fuel injector according to claim 1, wherein a sealing collar is provided on the actuator cover which sealing collar
in an axial and a radial direction preferably connects to the radial margin of the actuator cover and
serves as a guiding collar for the actuator cover and when laser-welding is a seal against an outflow of fused plastic from the overlapping area into the actuator chamber.

11. The fuel injector according to claim 1, wherein the axial margin and/or the radial margin and/or the sealing collar of the actuator cover run at least partially around in a peripheral direction on the substantially circular actuator cover.

12. The fuel injector according to claim 1, wherein the respective sealing collar of the actuator cover covers in a peripheral direction of the actuator cover a greater angular range than the relevant axial margin and/or the relevant radial margin.

13. The fuel injector according to claim 1, wherein on a periphery, preferably on an outer periphery, of the actuator cover is disposed, extending in an axial direction.

14. The fuel injector according to claim 13, wherein the axial margin and/or the radial margin and/or the sealing collar of the actuator cover is disposed at a spacing relative to the clip.

15. The fuel injector according to claim 13, wherein on the outer periphery of the actuator cover three clips are disposed in a distributed manner, and,
two clips are disposed opposite each other on the outer periphery of the actuator cover and the third clip is disposed on a section of the outer periphery midway between these two clips.

16. The fuel injector according to claim 1, wherein the casing on the actuator is embodied as an injection molding which
is embodied in particular as an injection-molded connector of a contact stud support of the actuator and serves for fixing the contact stud support on to the actuator.

17. The fuel injector according to claim 16, wherein the contact stud support secures a gas-permeable and liquid-tight sealing element on the actuator, both of which are protected by the actuator cover.

18. The fuel injector accordance to claim 1, wherein the casing in the inset area of the actuator cover is embodied in the shape of a hollow cylinder and optionally has clip recesses, running in an axial direction, for one or more clips.

19. The fuel injector according to claim 13, wherein, between a front side of the clip and the casing, the gap is provided which preferably continues in a labyrinthine manner further inward to the actuator chamber in the actuator.

20. The fuel injector according to claim 19, wherein the gap between actuator cover and casing continues on the inside of the actuator cover along the clip and preferably opens through a recess in the sealing collar into the actuator chamber.

21. The fuel injector according to claim 1, wherein the casing is produced from a plastic, in particular a Durethan®, and the actuator cover is produced from a different plastic, in particular a different Durethan®.

22. The fuel injector according to claim 21, wherein a material of the actuator cover has, at least in a circular central area, pigments which upon irradiation by means of a laser beam change optically in order in this way to obtain an improved contrast for labeling.

23. The fuel injector according to claim 1, wherein an internal diameter of the axial section of the casing is slightly smaller than an external diameter of the axial margin of the actuator cover.

24. The fuel injector according to claim 1, wherein the axial section of the casing has a through slot running in an axial direction.

25. The fuel injector according to claim 1, wherein the casing possesses in visible light a different reflectivity, perceptible with the human eye, preferably clearly perceptible, as the actuator cover.

26. An engine comprising a fuel injector with a housing for an actuator comprising a casing disposed around the actuator at least partially in a peripheral direction and an actuator cover placed on the casing, wherein, in an overlapping area between actuator cover and casing, the actuator cover is laser-welded to the casing, and
wherein the fuel injector is disposed substantially fully below a cylinder head of the engine.

27. A method for finishing a housing of a fuel injector with a housing for an actuator, a casing disposed around the actuator at least partially in a peripheral direction and an actuator cover placed on the casing, the method comprising the steps of:
using a laser beam for a laser-welding method in an overlapping area in a substantially perpendicular or substantially parallel orientation to the axial direction of the actuator wherein the laser-welding method laser-welds the actuator cover to the casing.

28. The method according to claim 27, wherein the laser beam for laser-welding which is incident over an outer periphery of the casing defines an angle of 80° to 100°, preferably 84° to 96°, particularly 86° to 94° and particularly preferably of 90±2° with the longitudinal axis of the actuator.

29. The method according to claim 27, wherein the laser beam for laser-welding which is incident on a periphery of the actuator cover defines an angle of +10° to −10°, preferably +6° to −6°, particularly +4° to −4° and particularly preferably of 0±2° with the longitudinal axis of the actuator.

30. The method according to claim 27, wherein the angle of incidence of the laser beam varies during the laser-welding and oscillates preferably in a range of ±15°, especially preferably ±10°, particularly ±6° and particularly preferably of ±4° about a mean position.

31. The method according to claim 27, wherein, during the laser-welding, by means of a force on the actuator cover in an axial direction and/or due to a force which the casing exerts on the actuator cover in a radial direction, a zero gap between actuator cover and casing is realized at least partially in the overlapping area.

32. The method according to claim 27, wherein, in an upstream or downstream method step, the preferably fully laser-absorbing actuator cover is laser-labeled on its outside, in particular with a data-matrix code.

33. A method for laser-labeling a component which is laser-transparent at a first wavelength,
in particular an actuator cover of a fuel injector with a housing for an actuator, a casing disposed around the actuator at least partially in a peripheral direction and an actuator cover placed on the casing, wherein, an overlapping area between actuator cover and casing, the actuator cover is laser-welded to the casing,
the method comprising the step of:
laser-labeling the component by means of a laser beam which has a second wavelength which differs from the first wavelength such that a change of contrast takes place on the component.

34. The method according to claim 33, wherein the two wavelengths of the laser beams are chosen such that the laser beam with the first wavelength can penetrate the component adequately and the laser beam with the second wavelength is absorbed by a surface area of the component to a substantial extent.

35. The method according to claim 33, wherein the component is at least in sections laser-transparent for an infrared wavelength and the laser beam used for laser-labeling possesses a wavelength in ultraviolet or in visible light.

36. The method according to claim 33, wherein the component is adjusted by means of laser additives such that discrete pigment changes occur during labeling by means of the laser beam of the second wavelength.

37. The method according to claim 33, wherein the component comprises an undyed plastic which is preferably gray or natural-colored, and the component is laser-labeled by means of a CO₂ laser).

38. The method according to claim 33, wherein the contrast change is recognizable by a code-reading device and is preferably perceptible or clearly perceptible with the human eye.

39. The method according to claim 33, wherein the component is laser-labeled by means of a data matrix code.

40. An actuator cover obtained from a method as claimed in claim 33.

41. The actuator cover according to claim 40, wherein the actuator cover, which is laser-transparent at an infrared wavelength, is laser-labeled by means of a blue laser beam or by means of a green laser beam.

42. The actuator cover according to claim 41, wherein the wavelength of the blue laser beam is 355 nm and the wavelength of the green laser beam is 532 nm.

43. The actuator cover according to claim 40, wherein the material of the actuator cover is Ultramid B3WG6LT sw23229 produced by BASF®.
